(19) United States
(12) Patent Application Publication
(10) Pub. No.: US 2024/0273048 A1
(43) Pub. Date: Aug. 15, 2024

(54) DATA OPERATION SYSTEM, DATA OPERATION METHOD, AND STORAGE MEDIUM

(71) Applicant: Alibaba (China) Co., Ltd., Hangzhou (CN)

(72) Inventors: Linyong HUANG, Shanghai (CN); Zhe ZHANG, Beijing (CN); Shuangchen LI, Sunnyvale, CA (US); Hongzhong ZHENG, Shanghai (CN)

(21) Appl. No.: 18/442,637

(22) Filed: Feb. 15, 2024

(30) Foreign Application Priority Data
Feb. 15, 2023 (CN) 202310146419.7

(51) Int. Cl. G06F 13/40

(52) U.S. Cl. CPC G06F 13/4045; G06F 13/4022; G06F 2213/0026

(57) ABSTRACT

A data operation system includes: a plurality of data processing units; a memory expansion unit communicatively coupled to the plurality of data processing units; a plurality of data operation units communicatively coupled to the plurality of data processing units and the memory expansion unit; and a plurality of first storage units communicatively coupled to the plurality of data processing units; wherein the memory expansion unit comprises a plurality of memory expansion cards, each of the plurality of data processing units is communicatively coupled to at least one of the plurality of memory expansion cards, and the plurality of memory expansion cards are interconnected.

### CROSS-REFERENCE TO RELATED APPLICATIONS

The disclosure claims the benefits of priority to Chinese Application No. 202310146419.7 filed Feb. 15, 2023, which is incorporated herein by reference in its entirety.

### TECHNICAL FIELD

The present disclosure generally relates to a graph neural network (GNN) architecture, and more particularly, to a data operation system, a data operation method, and a non-transitory computer readable medium for adapting to graph neural computing at different scales.

### BACKGROUND

A graph neural network (GNN) is a neural network that may directly operate on a graph. The GNN is more suitable for operating on the graph than a traditional neural network (such as a convolutional neural network), because the GNN may better adapt to graphs of arbitrary size or complex topology. The GNN may perform inference on unstructured data described in the graph format.

To perform GNN computation, large-scale graph data is usually processed using a distributed architecture. In the existing distributed architecture, a local central processing unit (CPU) needs to first perform sampling based on inputs of batch of root nodes, and obtain graph structure information and feature vectors from local and remote machines. Afterward, the feature vectors are sent to a dedicated graphics processing unit (GPU) to complete subsequent aggregation and combination operations. Compared to stand-alone processing, the main bottleneck in large-scale distributed GNN processing lies in high-latency graph sampling operations. In small and medium-scale GNNs, the main bottleneck lies in the imbalance load caused by irregular access patterns and computation. In a large-scale GNN, the main bottleneck lies in low utilization of storage bandwidth due to irregular access pattern, and becomes more serious in high-latency cross-distributed node communication.

Therefore, it is required to optimize the irregular access pattern of the graph neural network in the GNN distributed system.

### SUMMARY OF THE DISCLOSURE

Embodiments of the present disclosure provide a data operation system. The data operation system includes: a plurality of data processing units; a memory expansion unit communicatively coupled to the plurality of data processing units; a plurality of data operation units communicatively coupled to the plurality of data processing units and the memory expansion unit; and a plurality of first storage units communicatively coupled to the plurality of data processing units; wherein the memory expansion unit comprises a plurality of memory expansion cards, each of the plurality of data processing units is communicatively coupled to at least one of the plurality of memory expansion cards, and the plurality of memory expansion cards are interconnected.

Embodiments of the present disclosure provide a data operation method. The data operation method includes: sending a batch of root node identifiers to a memory expansion unit comprising a plurality of memory expansion cards; performing sampling and partial aggregation operations on the batch of root node identifiers by the plurality of memory expansion cards, and generating a plurality of first aggregation results; combining the plurality of first aggregation results to obtain a second aggregation result; and sending the second aggregation result to a data operation unit.

Embodiments of the present disclosure provide a non-transitory computer-readable storage medium that stores a set of instructions that is executable by one or more processors of an apparatus to cause the apparatus to perform operations. The operations include: sending a batch of root node identifiers to a memory expansion unit comprising a plurality of memory expansion cards; performing sampling and partial aggregation operations on the batch of root node identifiers by the plurality of memory expansion cards, and generating a plurality of first aggregation results; combining the plurality of first aggregation results to obtain a second aggregation result; and sending the second aggregation result to a data operation unit.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic structural diagram of an exemplary data operation system, according to some embodiments of the present disclosure.

FIG. 2 is a schematic structural diagram of an exemplary memory expansion unit, according to some embodiments of the present disclosure.

FIG. 3 is a schematic structural diagram of an exemplary memory expansion card, according to some embodiments of the present disclosure.

FIG. 4 is a schematic structural diagram of an exemplary near-memory processing module, according to some embodiments of the present disclosure.

FIG. 5 is a schematic structural diagram of an exemplary data operation system, according to some embodiments of the present disclosure.

FIG. 6 is a schematic diagram showing data transmission of an exemplary data operation method, according to some embodiments of the present disclosure.

FIG. 7 is a schematic flowchart of an exemplary data operation method, according to some embodiments of the present disclosure.

FIG. 8 is a schematic flowchart of another exemplary data operation method, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

In a traditional data processing architecture, a manner of first loading data from a memory to an internal memory and then processing the data in the internal memory through a data processing unit (e.g., a CPU) is usually adopted. However, the traditional data processing mode can no longer meet the demands of the era of big data. The data processing mode, such as near data processing (NDP) or near data computing (NDC), has emerged. Changing a processor-centric computing mode into a data-centric computing mode can greatly reduce data transmission and improve efficiency of data processing/computing.

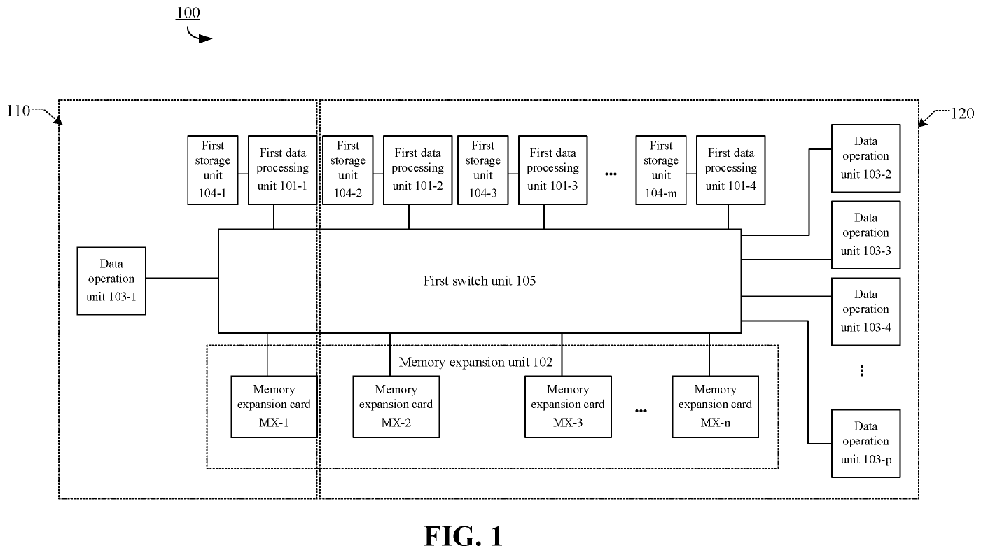

FIG. 1 is a schematic structural diagram of an exemplary data operation system 100, according to some embodiments of the present disclosure. As shown in FIG. 1, data operation system 100 includes a plurality of first data processing units 101-1, 101-2, 101-3, . . . , and 101-m, a memory expansion unit 102, a plurality of first data operation units 103-1, 103-2, 103-3, 103-4, . . . , and 103-p, and a plurality of first storage units 104-1, 104-2, 104-3, . . . , and 104-m. The first data processing units 101-1, 101-2, 101-3, . . . , and 101-m are communicatively coupled to the memory expansion unit 102 through a first switch unit 105.

The memory expansion unit 102 includes a plurality of memory expansion cards, for example, MX-1, MX-2, MX-3, . . . , and MX-n, which can be referred as a memory pool. Each of the first data processing units (e.g., 101-1, 101-2, 101-3, . . . , or 101-m) may be respectively communicatively coupled to one or more memory expansion cards (e.g., MX-1, MX-2, MX-3, . . . , or MX-n). For example, first data processing unit 101-1 may be communicatively coupled to memory expansion card MX-1, first data processing unit 101-2 may be communicatively coupled to memory expansion cards MX-2 and MX-3, and first data processing unit 101-3 may be communicatively coupled to a larger quantity of memory expansion cards. The quantity of memory expansion cards connected to each data processing unit may vary based on the data processing capability of a data processing unit and an amount of data processed. The present disclosure is not limited thereto.

The first switch unit 105 is provided between the memory expansion unit 102 and the first data processing units 101-1, 101-2, 101-3, . . . , and 101-m. The first switch unit 105 may be, for example, a peripheral component interconnect express (PCIe) interface, including one or more PCIe switches (not shown in the figure). Each of the plurality of PCIe switches corresponds to one of the first data processing units (e.g., 101-1, 101-2, 101-3, . . . , or 101-m) and the memory expansion card (e.g., MX-1, MX-2, MX-3, . . . , or MX-n) communicatively coupled to the first data processing unit (e.g., 101-1, 101-2, 101-3, . . . , or 101-m), to implement transmission of signals and data between the first data processing unit and the memory expansion card in an electrical and/or optical manner.

In the present disclosure, each of the first storage units (e.g., 104-1, 104-2, 104-3, . . . , and 104-m) is respectively connected to the first data processing units (e.g., 101-1, 101-2, 101-3, . . . , and 101-m). Each of the first data processing units (e.g., 101-1, 101-2, 101-3, . . . , and 101-m) may be, for example, a microprocessor, a processor, a computing processing unit, a digital signal processing unit, a system-on-chip (SoC) device, a complex instruction set computer (CISC) microprocessor, a reduced instruction set computer (RISC) microprocessor, or any other type of processor or processing circuit that an integrated circuit may implement. In addition, each of the first storage units (e.g., 104-1, 104-2, 104-3, . . . , and 104-m) may be a dynamic random access memory (DRAM), or may be any type of volatile memory and/or any type of non-volatile memory. The present disclosure is not limited thereto.

Similarly, the first data processing units (e.g., 101-1, 101-2, 101-3, . . . , and 101-m) are also communicatively coupled to the first data operation units (e.g., 103-1, 103-2, 103-3, 103-4, . . . , and 103-p) through the PCIe switch. Each of the first data processing units may be respectively communicatively coupled to one or more first data operation units. For example, first data processing unit 101-1 may be communicatively coupled to first data operation unit 103-1, first data processing unit 101-2 may be communicatively coupled to first data operation units 103-2 and 103-3, and first data processing unit 101-3 may be communicatively coupled to a larger quantity of first data operation units. The quantity of first data processing units connected to each first data operation unit may vary based on the data processing capability of the data processing unit and the amount of data processed. The present disclosure is not limited thereto. Each of the first data operation units (e.g., 103-1, 103-2, 103-3, 103-4, . . . , and 103-p) may be a GPU, a neural network processing unit (NPU), or a dedicated data processing unit (DPU), configured to implement distribution and scheduling of tasks. The present disclosure is not limited thereto.

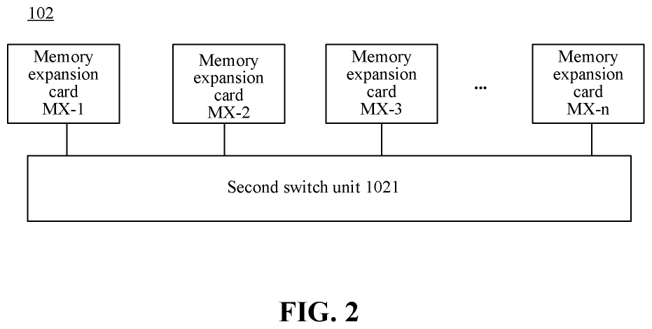

FIG. 2 is a schematic structural diagram of an exemplary memory expansion unit 102, according to some embodiments of the present disclosure. As shown in FIG. 1 and FIG. 2, the memory expansion unit 102 of the present disclosure includes a plurality of memory expansion cards MX-1, MX-2, MX-3, . . . , and MX-n. The plurality of memory expansion cards (e.g., MX-1, MX-2, MX-3, . . . , and MX-n) are interconnected through a second switch unit 1021. In other words, the second switch unit 1021 is provided among the plurality of memory expansion cards MX-1, MX-2, MX-3, . . . , and MX-n. The second switch unit 1021 may be, for example, a memory fabric switch (MFS) unit, configured to interconnect the plurality of memory expansion cards (e.g., MX-1, MX-2, MX-3, . . . , and MX-n) in a point-to-point structure, a hierarchical structure, a topological structure, or a combination structure of one or more of the point-to-point structure, the hierarchical structure, or the topological structure.

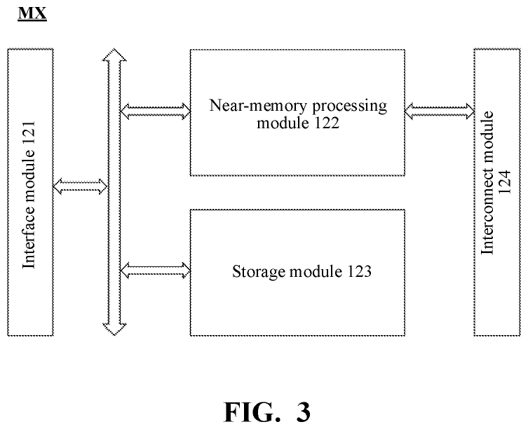

FIG. 3 is a schematic structural diagram of an exemplary memory expansion card MX, according to some embodiments of the present disclosure. As shown in FIG. 1 to FIG. 3, the memory expansion card MX of the present disclosure includes an interface module 121, a near-memory processing module 122, a storage module 123, and an interconnect module 124.

The interface module 121 is configured to receive requests from the first data processing units (e.g., 101-1, 101-2, 101-3, . . . , and 101-m), and is used for data transmission between the first data processing units (e.g., 101-1, 101-2, 101-3, . . . , and 101-m) and the first data operation units (e.g., 103-1, 103-2, 103-3, 103-4, . . . , and 103-p).

The near-memory processing module 122 is communicatively coupled to the interface module 121 and includes a plurality of functional units to support a plurality of sampling algorithms and aggregation functions for performing graph sampling and aggregation of feature vectors. The storage module 123 is communicatively coupled to the near-memory processing module 122 and configured to cache a graph structure and feature vectors sampled by the near-memory processing module 122 and store an aggregation result of the feature vectors. The storage module 123 is further configured to store partial graph structures and feature data.

The storage module 123 may be accessed by the near-memory processing module 122 in the memory expansion card MX where the storage module 123 is located, or may be accessed by the near-memory processing module 122 in another memory expansion card MX, or may be accessed by the first data processing units (e.g., 101-1, 101-2, 101-3, . . . , and 101-m) or the first data operation units (e.g., 103-1, 103-2, 103-3, 103-4, . . . , and 103-p) through the first switch unit 105 or the second switch unit 1021.

In the present disclosure, the storage module 123 may be a dynamic random access memory (DRAM), or may be any type of volatile memory and/or any type of non-volatile memory. The present disclosure is not limited thereto. To take full advantage of high bandwidth and low-latency access of the storage module 123 on the memory expansion card MX, the first data processing units (e.g., 101-1, 101-2, 101-3, . . . , and 101-m) may be configured to run only an operating system and control the near-memory processing module 122.

The interconnect module 124 is communicatively coupled to the near-memory processing module 122. The interconnect module 124 may be, for example, a memory fabric interface (MFI). The plurality of memory expansion cards (e.g., MX-1, MX-2, MX-3, . . . , and MX-n) in the memory expansion unit 102 are communicatively coupled to the second switch unit 1021 by the interconnect module 124, thereby realizing interconnection among the memory expansion cards MX-1, MX-2, MX-3, . . . , and MX-n.

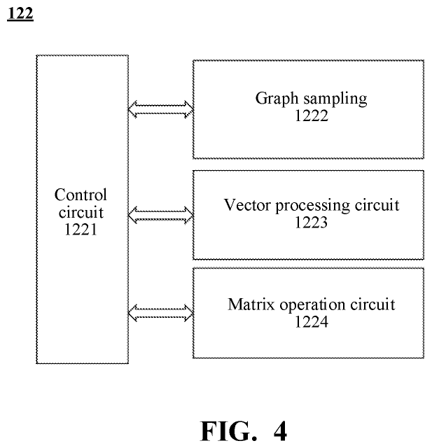

FIG. 4 is a schematic structural diagram of an exemplary near-memory processing module 122, according to some embodiments of the present disclosure. As shown in FIG. 1 to FIG. 4, the near-memory processing module 122 of the present disclosure includes a control circuit 1221, a graph sampling circuit 1222, a vector processing circuit 1223, and a matrix operation circuit 1224. The control circuit 1221 is communicatively coupled to the interface module 121 and configured to extract node data from the storage module 123 of the memory expansion card (e.g., MX-1, MX-2, MX-3, . . . , or MX-n) based on requests received from the first data processing units (e.g., 101-1, 101-2, 101-3, . . . , and 101-m), and send the node data to the graph sampling circuit 1222. The graph sampling circuit 1222 is communicatively coupled to the control circuit 1221 and configured to perform sampling based on the node data, and send a sampling result to the vector processing circuit 1223 and the matrix operation circuit 1224. The sampling may include a graphic structure sampling and a feature sampling. The vector processing circuit 1223 is communicatively coupled to the control circuit 1221 and configured to perform vector processing on the sampling result. The vector processing circuit 1223 may be various vector processing units (VPUs) that perform vector processing. The matrix operation circuit 1224 is communicatively coupled to the control circuit 1221 and configured to perform matrix operation on the sampling result. The matrix operation circuit 1224 may be various matrix operation units that perform matrix operations, for example, a general matrix multiplication (GEMM) operation unit. The present disclosure is not limited thereto.

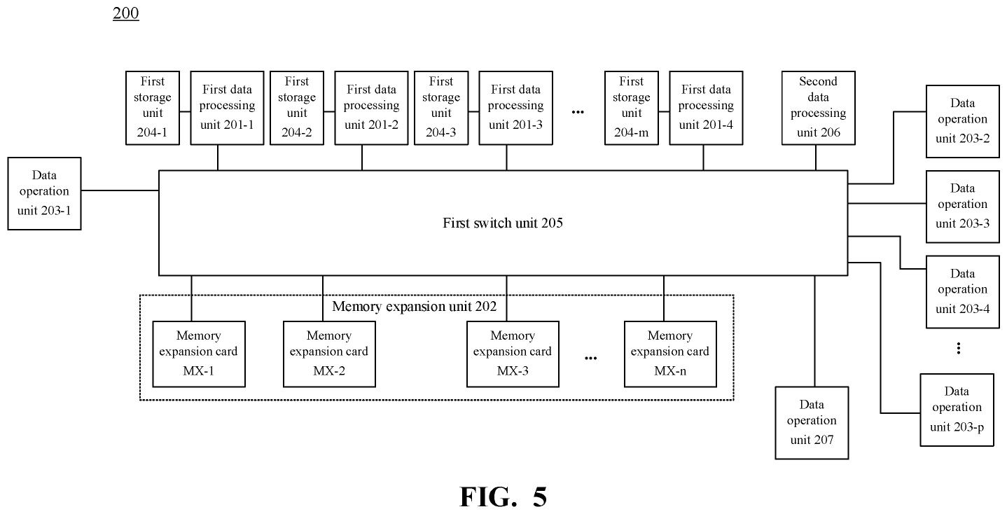

FIG. 5 is a schematic structural diagram of an exemplary data operation system 200, according to some embodiments of the present disclosure. As shown in FIG. 5, compared with the data operation system 100 shown in FIG. 1, the data operation system 200 further includes at least one second data processing unit 206 and at least one second data operation unit 207 in addition to a plurality of first data processing units (e.g., 201-1, 201-2, 201-3, . . . , and 201-m), a memory expansion unit 202, a plurality of first data operation units (e.g., 203-1, 203-2, 203-3, 203-4, . . . , and 203-p), and a plurality of first storage units (e.g., 204-1, 204-2, 204-3, . . . , and 204-m). The first data processing units (e.g., 201-1, 201-2, 201-3, . . . , and 201-m) are connected to the memory expansion unit 202 through the first switch unit 205. The second data processing unit 206 may be communicatively coupled to the second data operation unit 207 through the first switch unit 205, and may also be communicatively coupled to the second data operation unit 207 through another interface or interconnection. The present disclosure is not limited thereto.

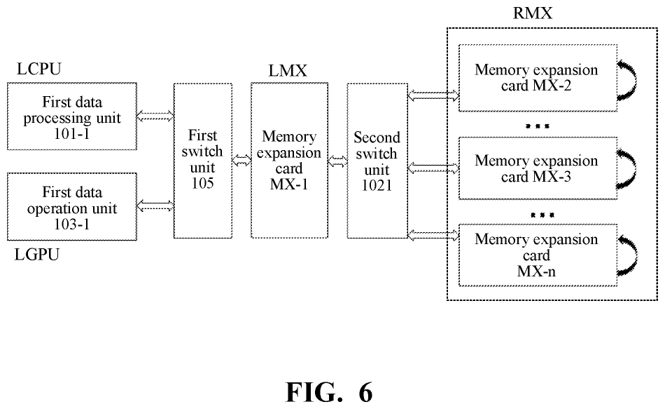

FIG. 6 is a schematic diagram showing data transmission of a data operation method, according to some embodiments of the present disclosure. Referring to FIG. 1 and FIG. 6, data operation system 100 includes a local operation module 110 and a remote operation module 120. Local operation module 110 includes the first data processing unit 101-1 defined as a local data processing unit LCPU, the memory expansion card MX-1 connected to the first data processing unit 101-1 and defined as a local memory expansion card LMX, the first data operation unit 103-1 connected to the first data processing unit 101-1 and defined as a local data operation unit LGPU, and the first storage unit 104-1 connected to the first data processing unit 101-1 and defined as a local storage unit LMU. Remote operation module 120 includes other data processing units (e.g., 101-2, 101-3, . . . , and 101-m), memory expansion cards (e.g., MX-2, MX-3, . . . , and MX-n), first data operation units (e.g., 103-2, 103-3, 103-4, . . . , and 103-p), and first storage units (e.g., 104-2, 104-3, . . . , and 104-m), which respectively defined as a remote data processing unit RCPU, a remote memory expansion card RMX, a remote data operation unit RGPU, and a remote storage unit RMU. Certainly, the definition may alternatively be performed in another manner.

When an access request sent by the local data processing unit LCPU to the local memory expansion card LMX based on the current batch of root node identifiers includes only an instruction to access the storage module 123, and does not include an instruction to operate the near-memory processing module 122 in the local memory expansion card LMX, that is in this case, the near-memory processing module 122 does not work, the local memory expansion card LMX and the remote memory expansion card RMX are only used as physical memories.

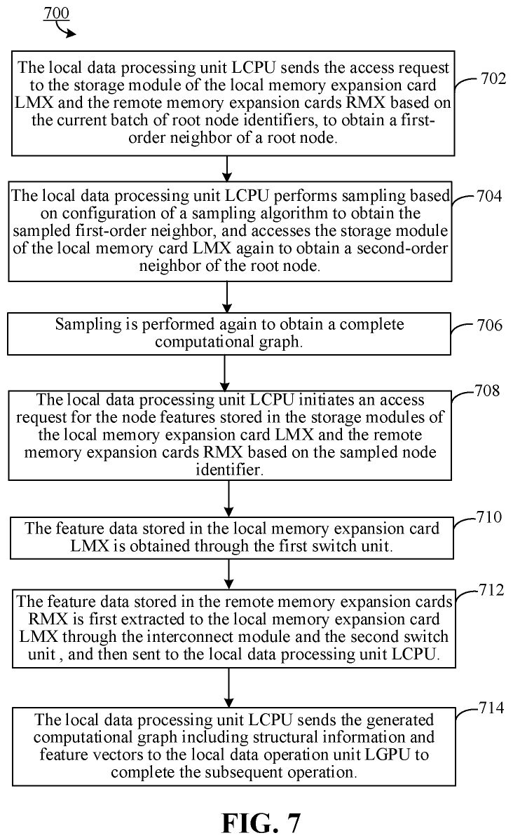

FIG. 7 is a schematic flowchart of an exemplary data operation method 700, according to some embodiments of the present disclosure. As shown in FIG. 1 to FIG. 7, the data operation method 700 of the present disclosure is applied to the data operation system 100 shown in FIG. 1 and the data operation system 200 shown in FIG. 5, and a structure of each functional unit or module shown in FIG. 2 to FIG. 4 is also considered. Referring to FIG. 1 and FIG. 7, the data operation method 700 of the present disclosure includes the steps 702 to 714.

At step 702, the local data processing unit LCPU (e.g., first data processing unit 101-1) sends the access request to the storage module 123 of the local memory expansion card LMX (e.g., memory expansion card MX-1) and the remote memory expansion cards RMX (e.g., memory expansion cards MX-2, MX-3, . . . and MX-n) based on the current batch of root node identifiers, to obtain a first-order neighbor of a root node.

At step 704, the local data processing unit LCPU (e.g., first data processing unit 101-1) performs sampling based on configuration of a sampling algorithm to obtain the sampled first-order neighbor, and accesses the storage module 123 of the local memory card LMX (e.g., memory expansion card MX-1) again to obtain a second-order neighbor of the root node.

At step 706, sampling is performed again to obtain a complete computational graph. The computational graph includes only structural data and does not include a feature vector of a node.

At step 708, the local data processing unit LCPU (e.g., first data processing unit 101-1) initiates an access request for the node features stored in the storage modules 123 of the local memory expansion card LMX (e.g., memory expansion card MX-1) and the remote memory expansion cards RMX (e.g., memory expansion cards MX-2, MX-3, . . . and MX-n) based on the sampled node identifier.

At step 710, the feature data stored in the local memory expansion card LMX (e.g., memory expansion card MX-1) is obtained through the first switch unit 105 (e.g., PCIe).

At step 712, the feature data stored in the remote memory expansion cards RMX (e.g., memory expansion cards MX-2, MX-3, . . . and MX-n) is first extracted to the local memory expansion card LMX (e.g., memory expansion card MX-1) through the interconnect module 124 and the second switch unit 1021, and then sent to the local data processing unit LCPU (e.g., first data processing unit 101-1).

At step 714, the local data processing unit LCPU (e.g., first data processing unit 101-1) sends the generated computational graph including structural information and feature vectors to the local data operation unit LGPU (e.g., first data operation unit 103-1) to complete the subsequent operation.

For another batch of root node identifiers, the foregoing steps may be repeated.

The data operation method 700 applied to the data operation system 200 shown in FIG. 5 is the same as the method applied to the data operation system 100 shown in FIG. 1. Details are not repeated herein again.

The execution process of the data operation method 700 without starting the near-memory processing module 122 mainly includes the following data transmission paths: (1) transmission of the structure and feature data from the local memory expansion card to the data processing units; (2) transmission of the structure and feature data from the remote memory expansion card the data processing unit; and (3) transmission of a computational graph between the data processing unit and the data operation unit. Although the interconnect module 124 in the memory expansion card MX can reduce the cost of remote memory access, the data transmission of paths (1) and (2) is irregular and discontinuous. Therefore, under-utilization of bandwidth may be caused, and the data operation unit remains idle until the data operation unit obtains the data from the data processing unit, which results in a serious waste of resources.

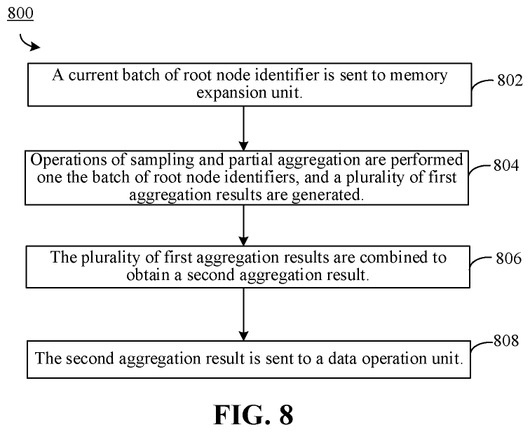

FIG. 8 is a schematic flowchart of another exemplary data operation method 800, according to some embodiments of the present disclosure. As shown in FIG. 1 to FIG. 6, and FIG. 8, the data operation method 800 of the present disclosure is applied to the data operation system 100 shown in FIG. 1 and the data operation system 200 shown in FIG. 5, and a structure of each functional unit or module shown in FIG. 2 to FIG. 4 is also considered. Referring to FIG. 1 to FIG. 4, and FIG. 8, the data operation method 800 of the present disclosure includes the steps 802 to 808.

At step 802, a current batch of root node identifier is sent to memory expansion unit 102. In some embodiment, the local data processing unit LCPU (e.g., first data operation unit 103-1) sends a batch of root node identifiers to the local memory expansion card LMX (e.g., memory expansion card MX-1) communicatively coupled to the local data processing unit LCPU (e.g., first data operation unit 103-1). Then, the local memory expansion card LMX (e.g., memory expansion card MX-1) sends the current batch of root node identifiers to each interconnect module 124 of the remote memory expansion cards RMX (e.g., memory expansion cards MX-2, MX-3, . . . and MX-n) through an interconnect module 124 of the local memory expansion card LMX (e.g., memory expansion card MX-1) and the second switch unit 1021 in the memory expansion unit 102. In the present disclosure, the current batch of root node identifiers may be sent to one remote memory expansion card RMX, or to a plurality of remote memory expansion cards RMX, and may be sent based on the data processing capability of the data processing unit and the amount of data processed. The present disclosure is not limited thereto.

At step 804, operations of sampling and partial aggregation are performed one the batch of root node identifiers, and a plurality of first aggregation results are generated. After the current batch of root node identifiers is received, each near-memory processing modules 122 in the local memory expansion card LMX and the remote memory expansion card RMX obtain node information and feature vectors from the storage module 123, and respectively perform operations of sampling and partial aggregation (i.e., first-level aggregation). The local memory card LMX and the remote memory card RMX respectively generate a plurality of first aggregation results (i.e., partial aggregation results).

At step 806, the plurality of first aggregation results are combined to obtain a second aggregation result. The remote memory expansion card RMX sends the generated first aggregation results to the local memory expansion card LMX, and then the local memory expansion card LMX combines the first aggregation results generated by the local memory card LMX and the remote memory card RMX, to obtain the second aggregation result.

At step 808, the second aggregation result is sent to a data operation unit. The local data processing unit LCPU then sends the second aggregation result obtained by the local memory expansion card LMX to the local data operation unit LGPU for subsequent combination and second-level aggregation operations. In the present disclosure, because the first-level aggregation has been completed before sending to local data operation unit LGPU, a computational graph of the first level may not be included when the second aggregation result is sent to the local data operation unit LGPU.

For another batch of root node identifiers, the foregoing steps may be repeated, but may be performed in a pipelined manner.

The data operation method 800 applied to the data operation system 200 shown in FIG. 5 is the same as the method applied to the data operation system 100 shown in FIG. 1. Details are not repeated herein again.

The data operation method 800 of the present disclosure mainly includes the following data transmission paths: (1) data transmission of root node identifiers between the local data processing unit LCPU and the local memory expansion card LMX as well as the remote memory expansion card RMX; (2) structural data transmission between the memory expansion cards MX; (3) transmission of aggregation results between the memory expansion cards MX; and (4) computational graph transmission between the local memory expansion card LMX and the local data operation unit LGPU. The foregoing transmitted data is regular and continuous, and therefore the bandwidth can be fully utilized.

It can be seen that, compared with the manner of using data processing units for graph processing, the present disclosure uses a near-memory processing module to complete data operation at a location close to the storage module, and may utilize local low-latency access to implement efficient sampling, which greatly reduces communication costs between distributed nodes and reduces time overheads of sampling.

In addition, because a largest number of second-order neighbors and the feature vectors do not need to be transmitted, transmission of the computational graph between the memory expansion card MX and the data processing unit also leads to a smaller data volume. Moreover, the data processing unit offloads a large amount of data operation work to a plurality of near-memory processing modules. The near-memory processing module within each memory expansion card MX processes only the feature vector involving the node within the current memory expansion card. This may avoid transmission of a large number of irregular cross-node feature vectors.

Finally, the data transmission among the memory expansion cards MX and the data transmission between the memory expansion card MX and the data processing unit include only partial aggregation results in addition to graph structure information. The data may be packaged as a whole to complete the transmission at one time, avoiding fragmented and discontinuous access, thereby fully utilizing memory bandwidth to implement low-latency transmission.

Each process, method, and algorithm described in the preceding sections may be embodied in and fully or partially automated by a code module executed by one or more computer systems or computer processors (including computer hardware). These processes and algorithms may be partially or fully implemented in application-specific circuits.

When the functions disclosed in the present disclosure are implemented in the form of software functional units and sold or used as stand-alone products, the functions may be stored in a non-volatile computer-readable storage medium executable by a processor. The specific technical solutions (in whole or in part) or aspects that contribute to the current technology disclosed herein may be embodied in the form of software products. The software product may be stored in a storage medium. The storage medium includes a plurality of instructions to enable a computing device (which may be a personal computer, a server, a network device, and the like) to perform all or part of the steps of the method of the embodiments of this application. The storage medium may include a flash drive, a portable hard drive, a ROM, a RAM, a magnetic disk, an optical disk, another medium that may be configured to store program code, or any combination thereof.

A specific embodiment further provides a system. The system includes a processor and a non-transitory computer-readable storage medium that stores instructions executable by a processor, to enable the system to perform operations corresponding to steps in the method in any of the foregoing embodiments. A specific embodiment further provides a non-transitory computer-readable storage medium. The storage medium is configured with instructions that may be executed by one or more processors, to enable one or more processors to perform operations corresponding to steps in any of the methods of the foregoing embodiments.

The embodiments disclosed herein may be implemented through a cloud platform, a server, or a server group (collectively referred to as a “service system” below) that interacts with a client. The client may be a terminal device, or a client registered by a user at the platform, where the terminal device may be a mobile terminal, a personal computer (PC), and any device on which a platform application may be installed.

The foregoing various features and processes may be used independently of each other or may be combined in various manners. All possible combinations and sub-combinations are intended to fall within the scope of the present disclosure. In addition, some methods or process modules may be omitted in some implementations. The methods and processes described herein are not limited to any specific order, and blocks or states related to the methods and processes may be executed in another proper order. For example, the described blocks or states may be executed in an order that is not specifically disclosed, or a plurality of blocks or states may be combined in one block or state. Example blocks or states may be executed consecutively, simultaneously, or in other manners. The blocks or states may be added to or removed from the disclosed example implementation. The configuration of an example system and component described herein may be different from that described. For example, compared to the disclosed example implementation, elements may be added, removed, or rearranged.

Various operations of the example method described herein may be at least partially performed through algorithms. The algorithm may include program code or instructions stored in a memory (for example, the foregoing non-transitory computer-readable storage medium). The algorithm may include a machine learning algorithm. In some embodiments, the machine learning algorithm may not explicitly program a computer to execute the function, but may learn from training data to generate a prediction model that executes the function.

Various operations of the example method described herein may be at least partially performed by one or more processors temporarily configured (for example, through software) or permanently configured to perform relevant operations. Whether configured temporarily or permanently, these processors may form an engine implemented by the processors, which operates to perform one or more operations or functions described herein.

The methods described herein may be at least partially implemented by a processor, with one or more specific processors being used as examples of hardware. For example, at least some operations of a method may be performed by one or more processors or an engine implemented by the processors. In addition, one or more processors may also operate in a cloud computing environment or as a software as a service (SaaS) to support the performance of related operations. For example, at least some operations may be performed by a group of computers (for example, a machine that includes a processor), and the operations may be accessed via a network (for example, the Internet) and one or more suitable interfaces (for example, an application programming interface (API)).

The performance of some operations may be distributed among processors, not only residing within a single machine, but also deployed on a plurality of machines. In some example embodiments, the processor or the engine implemented by the processor may be located in a single geographic location (for example, in a home environment, an office environment, or a server farm). In another example implementation, the processor or the engine implemented by the processor may be distributed across a plurality of geographic locations.

The embodiments may further be described using the following clauses:

1. A data operation system, comprising:
a plurality of data processing units;
a memory expansion unit communicatively coupled to the plurality of data processing units;
a plurality of data operation units communicatively coupled to the plurality of first data processing units and the memory expansion unit; and
a plurality of first storage units communicatively coupled to the plurality of data processing units; wherein the memory expansion unit comprises a plurality of memory expansion cards, each of the plurality of data processing units is communicatively coupled to at least one of the plurality of memory expansion cards, and the plurality of memory expansion cards are interconnected.

2. The system according to clause 1, further comprising:
a first switch unit provided between the memory expansion unit and the plurality of data processing units, and configured to transmit data between the memory expansion unit and the plurality of data processing units.

3. The system according to clause 2, wherein the first switch unit comprises a plurality of peripheral component interconnect express (PCIe) switches, and each of the plurality of PCIe switches corresponds to one of the plurality of data processing units and at least one of the plurality of memory expansion cards.

4. The system according to clause 3, wherein each of the plurality of memory expansion cards further comprises:
an interface module configured to transmit data with the plurality of data processing units and the plurality of data operation units;
a near-memory processing module communicatively coupled to the interface module and configured to perform sampling and partial aggregation;
a storage module communicatively coupled to the near-memory processing module and configured to store a sampled result and an aggregation result; and
an interconnect module communicatively coupled to the near-memory processing module and configured to interconnect with other memory expansion cards.

5. The system according to clause 4, wherein the near-memory processing module is configured to perform graph sampling and aggregation of feature vectors.

6. The system according to clause 4, wherein the memory expansion unit further comprises:
a second switch unit provided between the plurality of memory expansion cards and communicatively coupled to the interconnect module of each of the plurality of memory expansion cards, wherein the second switch unit is configured to interconnect the plurality of memory expansion cards in a point-to-point structure, a hierarchical structure, a topological structure, or a combination structure of one or more of the point-to-point structure, the hierarchical structure, or the topological structure.

7. The system according to clause 5, wherein the near-memory processing module further comprises:
a control circuit communicatively coupled to the interface module and configured to extract node data from the storage module;
a graph sampling circuit communicatively coupled to the control circuit and configured to perform sampling on the node data to obtain a sampling result;
a vector processing circuit communicatively coupled to the control circuit and configured to perform vector processing on the sampling result; and
a matrix operation circuit communicatively coupled to the control circuit and configured to perform matrix operation on the sampling result.

8. A data operation method, applied to the system according to any one of clauses 1 to 7, wherein the data operation method comprises:
sending a batch of root node identifiers to a memory expansion unit comprising a plurality of memory expansion cards;
performing sampling and partial aggregation operations on the batch of root node identifiers by the plurality of memory expansion cards, and generating a plurality of first aggregation results;
combining the plurality of first aggregation results to obtain a second aggregation result; and
sending the second aggregation result to a data operation unit.

9. The method according to clause 8, wherein the plurality of memory expansion cards includes a local memory expansion card and at least one remote memory expansion card, and sending the batch of root node identifiers to the memory expansion unit further comprises:
sending, by a data processing unit, the batch of root node identifiers to the local memory expansion card; and
sending, by the local memory expansion card, the batch of root node identifiers to the at least one remote memory expansion card.

10. The method according to clause 9, wherein each of the local memory expansion card and the at least one remote memory expansion card comprises a near-memory processing module, and the sampling and the partial aggregation operations are performed by the near-memory processing module.

11. The method according to clause 10, wherein the second aggregation result comprises a computational graph.

12. The method according to clause 10, wherein combining the first aggregation results to obtain the second aggregation result is performed by the local memory expansion card.

13. A computing device, comprising the data operation system according to any one of clauses 1 to 7.

14. A storage medium, configured to store a computer program, wherein the computer program is used for performing the data operation method according to any one of clauses 8 to 12.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A data operation system, comprising:
a plurality of data processing units;
a memory expansion unit communicatively coupled to the plurality of data processing units;
a plurality of data operation units communicatively coupled to the plurality of data processing units and the memory expansion unit; and
a plurality of first storage units communicatively coupled to the plurality of data processing units; wherein the memory expansion unit comprises a plurality of memory expansion cards, each of the plurality of data processing units is communicatively coupled to at least one of the plurality of memory expansion cards, and the plurality of memory expansion cards are interconnected.

2. The system according to claim 1, further comprising:
a first switch unit provided communicatively between the memory expansion unit and the plurality of data processing units, and configured to transmit data between the memory expansion unit and the plurality of data processing units.

3. The system according to claim 2, wherein the first switch unit comprises a plurality of peripheral component interconnect express (PCIe) switches, and each of the plurality of PCIe switches corresponds to one of the plurality of data processing units and at least one of the plurality of memory expansion cards.

4. The system according to claim 3, wherein each of the plurality of memory expansion cards further comprises:
an interface module configured to transmit data with the plurality of data processing units and the plurality of data operation units;
a near-memory processing module communicatively coupled to the interface module and configured to perform sampling and partial aggregation;
a storage module communicatively coupled to the near-memory processing module and configured to store a sampled result and an aggregation result; and
an interconnect module communicatively coupled to the near-memory processing module and configured to interconnect with other memory expansion cards.

5. The system according to claim 4, wherein the near-memory processing module is configured to perform graph sampling and aggregation of feature vectors.

6. The system according to claim 4, wherein the memory expansion unit further comprises:
a second switch unit provided communicatively between the plurality of memory expansion cards and communicatively coupled to the interconnect module of each of the plurality of memory expansion cards, wherein the second switch unit is configured to interconnect the plurality of memory expansion cards in a point-to-point structure, a hierarchical structure, a topological structure, or a combination structure of one or more of the point-to-point structure, the hierarchical structure, or the topological structure.

7. The system according to claim 6, wherein the plurality of memory expansion cards comprises a local memory expansion card and at least one remote memory expansion card, the local memory expansion card is further configured to combine a plurality of first aggregation results to obtain a second aggregation result.

8. The system according to claim 7, wherein the plurality of data processing units comprises a local data processing unit, the local data processing unit is configured to send a batch of root node identifiers to the local memory expansion card; and the local memory expansion card is further configured to send the batch of root node identifiers to the at least one remote memory expansion card.

9. The system according to claim 5, wherein the near-memory processing module further comprises:
a control circuit communicatively coupled to the interface module and configured to extract node data from the storage module;
a graph sampling circuit communicatively coupled to the control circuit and configured to perform sampling on the node data to obtain a sampling result;
a vector processing circuit communicatively coupled to the control circuit and configured to perform vector processing on the sampling result; and
a matrix operation circuit communicatively coupled to the control circuit and configured to perform matrix operation on the sampling result.

10. A data operation method, comprising:
sending a batch of root node identifiers to a memory expansion unit comprising a plurality of memory expansion cards;
performing sampling and partial aggregation operations on the batch of root node identifiers by the plurality of memory expansion cards, and generating a plurality of first aggregation results;
combining the plurality of first aggregation results to obtain a second aggregation result; and
sending the second aggregation result to a data operation unit.

11. The method according to claim 10, wherein the plurality of memory expansion cards includes a local memory expansion card and at least one remote memory expansion card, and sending the batch of root node identifiers to the memory expansion unit further comprises:
sending, by a data processing unit, the batch of root node identifiers to the local memory expansion card; and
sending, by the local memory expansion card, the batch of root node identifiers to the at least one remote memory expansion card.

12. The method according to claim 11, wherein each of the local memory expansion card and the at least one remote memory expansion card comprises a near-memory processing module, and the sampling and the partial aggregation operations are performed by the near-memory processing module.

13. The method according to claim 12, wherein the second aggregation result comprises a computational graph.

14. The method according to claim 12, wherein combining the first aggregation results to obtain the second aggregation result is performed by the local memory expansion card.

15. A non-transitory computer readable medium that stores a set of instructions that is executable by one or more processors of an apparatus to cause the apparatus to perform operations comprising:
sending a batch of root node identifiers to a memory expansion unit comprising a plurality of memory expansion cards;
performing sampling and partial aggregation operations on the batch of root node identifiers by the plurality of memory expansion cards, and generating a plurality of first aggregation results;
combining the plurality of first aggregation results to obtain a second aggregation result; and
sending the second aggregation result to a data operation unit.

16. The non-transitory computer readable medium according to claim 15, wherein the operations further comprise:
sending, by a data processing unit, the batch of root node identifiers to a local memory expansion card; and
sending, by the local memory expansion card, the batch of root node identifiers to at least one remote memory expansion card.

17. The non-transitory computer readable medium according to claim 15, wherein the second aggregation result comprises a computational graph.
